(19) United States
(12) Patent Application Publication
(10) Pub. No.: US 2022/0250898 A1
(43) Pub. Date: Aug. 11, 2022

(54) SYSTEM FOR DISPENSING A UREA SOLUTION COMPRISING A TRANSPORTABLE CONTAINER AND ASSOCIATED DISPENSING DEVICE

(71) Applicant: TOTAL MARKETING SERVICES, PUTEAUX (FR)

(72) Inventors: Pierre DAVERAT, VOURLES (FR); Olivier GUÉNA, IRIGNY (FR); Romain BUTAUD, CONDRIEU (FR); Jean-Michel HIÉRONIMUS, ST PRIEST (FR)

(73) Assignee: TOTAL MARKETING SERVICES, PUTEAUX (FR)

(21) Appl. No.: 17/628,939

(22) PCT Filed: Jul. 23, 2020
(86) PCT No.: PCT/EP2020/070757

§ 371 Date: Jan. 21, 2022

(30) Foreign Application Priority Data
Jul. 24, 2019 (FR) FR1908413

(51) Int. Cl. B67D 7/02; B67D 7/74; B67D 7/78; B67D 7/84

(52) U.S. Cl. CPC B67D 7/02; B67D 7/845; B67D 7/78; B67D 7/74

(57) ABSTRACT

The dispensing system comprises a transportable container and, inside the container, comprises at least a first vessel containing a urea solution, at least a second vessel containing an additive for the urea solution, and at least a first set of fluidic circuits, comprising a first fluidic circuit, connecting the first vessel to a junction, at least a second fluidic circuit, connecting the second vessel to the junction, the second fluidic circuit comprising a valve that can be configured between an open position, in which the first and second fluidic circuits are in fluid communication, and a closed position, and a first dispensing circuit.

### CROSS REFERENCE TO RELATED APPLICATIONS

The present application is a U.S. National Phase Application under 35 U.S.C. § 371 of International Patent Application No. PCT/EP2020/070757 filed Jul. 23, 2020, which claims priority of French Patent Application No. FR 19 08413 filed Jul. 24, 2019. The entire contents of which are hereby incorporated by reference.

### FIELD OF INVENTION

The present invention relates to a dispensing system for dispensing a urea solution for a vehicle, in particular for a diesel vehicle, comprising at least a first vessel containing a urea solution.

### BACKGROUND

In an exhaust line of a diesel vehicle, a selective catalytic reducer (SCR) aftertreatment step is provided, during which a reduction of NOx or nitrogen oxides is carried out in a catalyst containing platinum and palladium, and in the presence of gaseous ammonia.

To introduce the gaseous ammonia into the exhaust, it is known to produce it directly in the conduit before the SCR by vaporizing an aqueous urea solution which, placed at an average temperature generally oscillating from 200° C. to 400° C., gradually decomposes into gaseous ammonia. However, in certain SCR and urea injection device configurations, manufacturers have noted the appearance of deposits in the exhaust pipes before the SCR inlet, which can cause partial or total clogging of the exhaust pipe and thus create engine power losses.

When using this aqueous urea solution, it is necessary to add at least one additional additive to enable the urea solution to further reduce the concentration of nitrogen oxides in the exhaust gas of a diesel vehicle and to avoid deposits that cause a loss of engine power. For this purpose, a preparation system can be installed in a urea solution production center, to be able to selectively prepare and dispense the urea solution mixed with at least one additive or the urea solution without additive.

However, such a dispensing system is not fully satisfactory. Adding the additive to the urea solution in a production center makes it difficult to manage the urea solution and additive containers. In addition, for remote locations with difficult access, it is impractical to transport large containers to these locations to prepare the urea solution. In particular, the dispensing of a urea solution is complicated for locations where there are few or no gas stations.

In addition, it is particularly difficult to prepare a small amount of urea solution with or without an additive suitable for the needs of individual consumers.

### SUMMARY

A purpose of the invention is to make the dispensing system more flexible and to make it possible to dispense the urea solution, with or without additive, even in remote areas.

To this end, the invention concerns a dispensing system for dispensing a urea solution, comprising a transportable container and comprising, inside the container:
at least a first vessel containing a urea solution,
at least a second vessel containing an additive for the urea solution, and
at least a first set of fluidic circuits, comprising:
   a first fluidic circuit, connecting the first vessel to a junction,
   at least a second fluidic circuit, connecting the second vessel to the junction, the junction placing the second fluidic circuit in fluidic communication with the first fluidic circuit
the second fluidic circuit comprising a first valve, configurable between an open position in which the first fluidic circuit is in fluidic communication with the second fluidic circuit so as to mix the urea solution and the additive, and a closed position, in which fluidic communication between the first fluidic circuit and the second fluidic circuit is interrupted, and
   a first dispensing circuit, connected to the junction, the first dispensing circuit comprising a first outlet adapted to deliver the urea solution mixed with the additive or the urea solution without the additive.

When a urea solution with additive is to be dispensed, the additive is added to the urea solution at the dispensing location instead of at a remote production center, i.e., closer to the consumer. This allows for better management of the urea solution and additives, makes the entire dispensing system transportable, and avoids the difficulty of moving large receptacles to remote locations. In addition, the dispensing system is capable of preparing a small amount of urea solution, with or without additives, to meet individual needs without requiring access to a gas station.

According to particular embodiments, the dispensing system further has one or more of the following optional features, taken alone or in any possible combination(s):
the urea solution is an aqueous urea solution, the urea concentration in the aqueous solution being substantially equal to 32.5% and meeting the ISO 22241 standard;
the dispensing system comprises a second set of fluidic circuits, comprising:
   a first additional fluidic circuit, connecting the first vessel to an additional junction,
   at least a second additional fluidic circuit, connecting the second vessel to the additional junction, the additional junction placing the second additional fluidic circuit in fluidic communication with the first additional fluidic circuit ,
the second additional fluidic circuit comprising a second valve, configurable between an open position in which the first additional fluidic circuit is in fluidic communication with the second additional fluidic circuit so as to mix the urea solution and the additive, and a closed position in which fluidic communication between the first additional fluidic circuit and the second additional fluidic circuit is interrupted, and
   a second dispensing circuit, connected to the additional junction, the second dispensing circuit comprising a second outlet adapted to deliver the urea solution mixed with the additive or the urea solution without the additive;
the second fluidic circuit of the first set of fluidic circuits and/or the second additional fluidic circuit of the second set of fluidic circuits comprises a metering pump capable of regulating the amount of additive flowing to the respective junction;
the first dispensing circuit of the first set of fluidic circuits and/or the second dispensing circuit of the second set of fluidic circuits comprises a transfer pump configured to transfer the urea solution, with or without additive, to the respective outlet;
the second set of fluidic circuits comprises a direct fluidic circuit of the urea solution, connecting the first vessel to the second outlet of the second set of fluidic circuits, the direct fluidic circuit being without a pump;
the first vessel has a volume greater than or equal to 1 m³;
the additive is selected among polyalkoxylated alcohols, preferably having ethoxylated and/or propoxylated groups, preferably having a hydrophilic/lipophilic balance of between 7 and 17;
the dispensing system comprises, inside the container:
   at least a third vessel of an additional additive for the urea solution,
   at least one third fluidic circuit connecting the third vessel to the junction, the junction placing the third fluidic circuit in fluidic communication with the first and second fluidic circuits,
the third fluidic circuit comprising a valve, configurable between an open position in which the first and second fluidic circuits are in fluidic communication with the third fluidic circuit so as to mix the urea solution with the additive and/or with the additional additive, and a closed position in which fluidic communication between the first and second fluidic circuits and the third fluidic circuit is interrupted,
the first outlet being capable of delivering the urea solution mixed with the additive, the urea solution mixed with the additional additive, the urea solution mixed with the additive and the additional additive, or the urea solution without the additive and additional additive.

The invention also concerns a dispensing installation comprising a dispensing system as described above and a receptacle fluidically connected to the first outlet, the dispensing system being capable of injecting the urea solution mixed with the additive or the urea solution without the additive into the canister.

According to one particular embodiment, the dispensing installation further comprises a final product tank fluidically connected to the second outlet, the dispensing system being capable of injecting the urea solution mixed with the additive or the urea solution without the additive into the final product tank, the volume of the final product tank having a volume strictly greater than the volume of the canister.

### BRIEF DESCRIPTION OF THE DRAWINGS

The invention will be better understood from the following description, given only by way of example, and made with reference to the appended drawings, in which:

FIG. 1 is a schematic view of a dispensing installation for dispensing a urea solution according to one embodiment of the invention;

FIG. 2 is a schematic perspective view of a dispensing system of the dispensing installation according to one embodiment of the invention;

FIG. 3 is a perspective view of the first and second fluidic circuits and the first dispensing circuit of the dispensing system of FIG. 2; and

FIG. 4 is a perspective view of a urea dispensing installation according to another embodiment.

### DETAILED DESCRIPTION

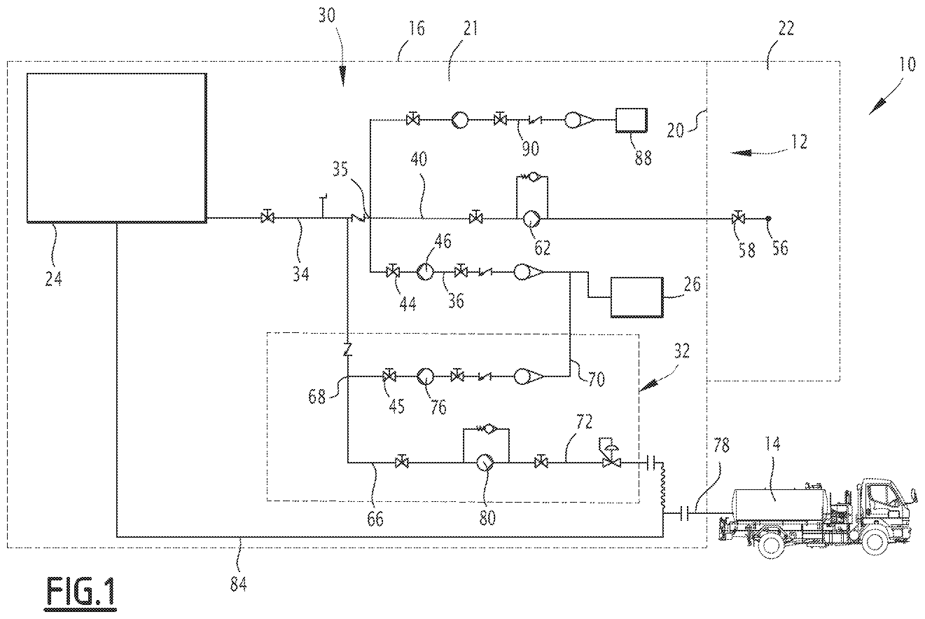

FIG. 1 shows a dispensing installation 10. The installation 10 comprises a dispensing system 12 for dispensing a urea solution. Advantageously, the device 10 also comprises a receptacle (not shown in the Figures), adapted to be fluidically connected to the dispensing system 12 to be filled with the urea solution mixed with an additive or without said additive, as will be described later. Advantageously, the installation 10 also comprises a reservoir 14 of the urea solution, adapted to be fluidically connected to the dispensing system 12. Advantageously, the installation 10 also comprises a final product tank (not shown in the Figures), adapted to be fluidically connected to the dispensing system 12.

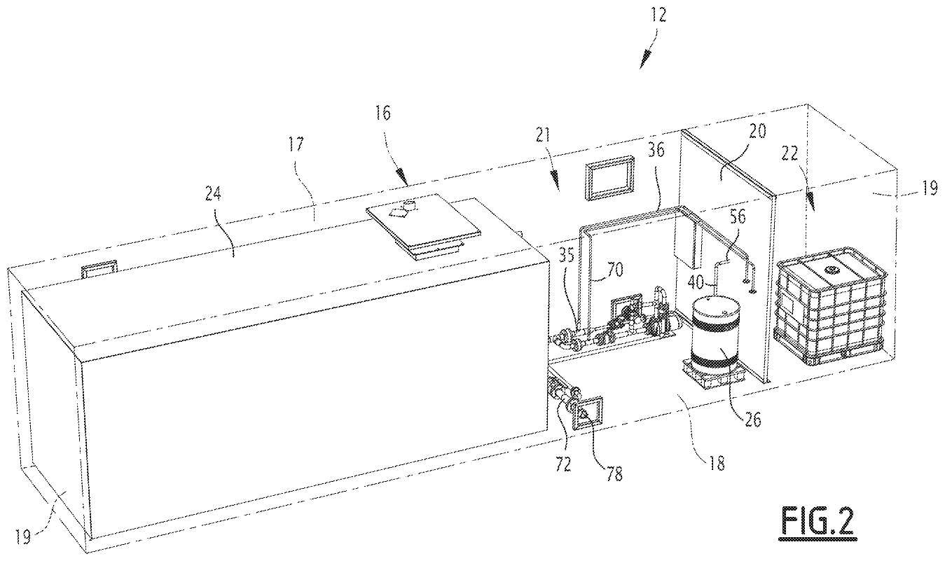

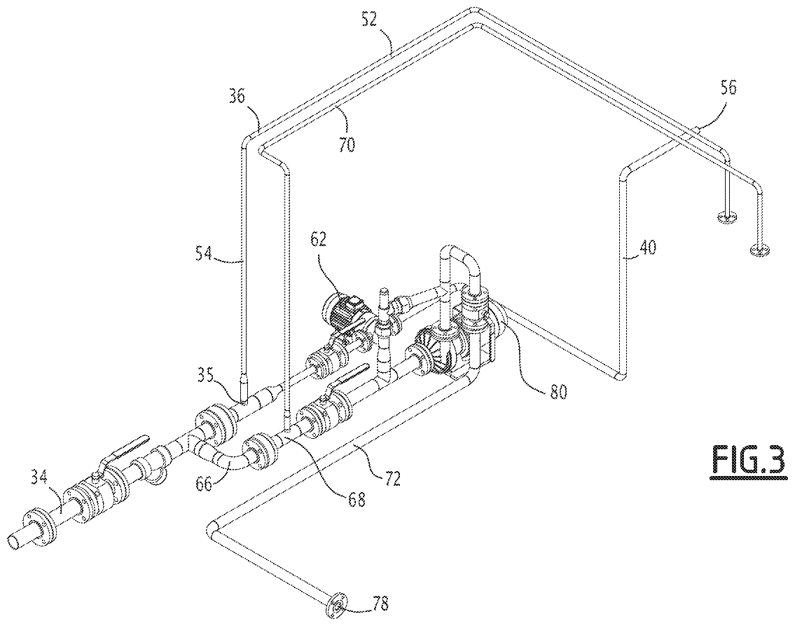

FIGS. 2 and 3 illustrate the dispensing system 12 for dispensing an aqueous urea solution derived from solid urea and demineralized water. Such an aqueous urea solution forms a diesel exhaust fluid for converting most of the nitrogen oxides in the exhaust gas into nitrogen and water vapor. The urea concentration in an aqueous solution is approximately 32.5% and meets the ISO22241 standard. Such a urea solution is described in document FR 3 053 603, for example. Such a solution is commonly known under the trade name “Adblue”.

The urea is provided in the form of solid urea agglomerates, for example. The agglomerates are in the form of balls, for example. The solid urea is then dissolved in water to form a urea solution. Then, the urea solution is put into vessels.

The dispensing system 12 comprises a transportable container 16. The transportable container 16 is a cargo transport container, in particular according to the ISO 668 and ISO 1496 container construction standards.

In FIG. 2, for clarity of the drawings, the container 16 is shown schematically in mixed lines.

According to a first embodiment of the invention as illustrated in FIGS. 2 through 3, the transportable container 16 is a 40-foot container. According to a second embodiment, the container is a 20-foot container.

“Transportable” means that the container 16 is mountable on and capable of being moved by a transport vehicle such as a truck, car, or rail vehicle.

The transportable container 16 comprises a ceiling 17, a floor 18, and four side walls 19. The ceiling 17, floor 18, and side walls 19 define an internal volume of the transportable container 16.

Optionally, the transportable container 16 comprises a partition wall 20 arranged within the internal volume. The partition wall 20 separates the internal volume into a first compartment 21 and a second compartment 22, separate from the first compartment 21.

The first compartment 21 comprises at least one first vessel 24, containing the liquid urea solution prepared as described above, at least one second vessel 26, containing an additive for the urea solution, and a first set 30 of fluidic circuits. According to an optional advantageous embodiment, the first compartment 21 also comprises a second set 32 of fluidic circuits.

The first vessel 24 preferably has a volume greater than or equal to 1 m³, preferably a volume greater than or equal to 2 m³, preferably a volume greater than or equal to 5 m³, preferably a volume greater than or equal to 10 m³, preferably a volume greater than or equal to 20 m³, even more preferably greater than or equal to 30 m³.

The first vessel 24 is advantageously adapted to be fixed in the transportable container 16, for example to one of the side walls 19 or to the partition wall 20. This anchoring of the first vessel 24 makes it possible in particular to avoid spillage when the transportable container 16 is moved.

The second vessel 26 preferably has preferably a volume of between 5 L and 1000 L, and is preferably equal to 208 L. Throughout the application, and unless otherwise indicated, the limits of a value range are included within that range, including in the phrases “between” and “varying/ranging from . . . to . . . ”.

Advantageously, the second vessel 26 is adapted to be fixed in the transportable container 16, preferably to one of the side walls 19 or to the partition wall 20. In particular, this anchoring of the second vessel 26 makes it possible to avoid spillage when the transportable container 16 is moved.

The additive in the second vessel 26 is preferably a polyfunctional additive selected among polyalkoxylate alcohols having ethoxylated and/or propoxylated groups with a hydrophilic/lipophilic balance of between 7 and 17.

The hydrophilic/lipophilic balance can be measured according to the Griffin method or according to the Davies method.

More precisely, the polyalkoxylate alcohols are selected among linear or branched polyalkoxylate fatty alcohols comprising carbon chains of 3 to 40 carbon atoms and 5 to 10 alkoxylate units and preferably having a hydrophilic/lipophilic balance ranging from 10 to 15.

The first set 30 of fluidic circuits comprises a first fluidic circuit 34 connecting the first vessel 24 to a junction 35, at least one second fluidic circuit 36 connecting the second vessel 26 to the junction 35, and a first dispensing circuit 40 connected to the junction 35. Thus, the junction 35 places the second fluidic circuit 36 in fluidic communication with the first fluidic circuit 34.

Preferably, the connection of the first vessel 24 to the first fluidic circuit 34 is made via a nozzle provided at one end of the first fluidic circuit 34 and threaded onto a connecting valve of the first vessel 24.

The second fluidic circuit 36 comprises a first valve 44, configurable between an open and a closed position. When the first valve 44 is open, the first fluidic circuit 34 is in fluidic communication with the second fluidic circuit 36 so as to mix the urea solution and the additive. When the first valve 44 is closed, fluidic communication between the first fluidic circuit 34 and the second fluidic circuit 36 is interrupted.

The first valve 44 is preferably manually operable. In a variant, the actuation of the first valve 44 is automated.

Advantageously, the second fluidic circuit 36 comprises a first metering pump 46 capable of controlling the amount of the additive flowing to the junction 35. The first metering pump 46 of the second fluidic circuit 36 is preferably capable of transferring a liquid at a flow rate of between 45 mL/min and 70 mL/min, and advantageously equal to 56 mL/min. This relatively low flow rate is compatible with the preparation of a final product for individual receptacles whose relatively small internal volume requires a relatively small amount of additive.

The second fluidic circuit 36 preferably comprises a first horizontal conduit 52 and a first vertical conduit 54. The first horizontal conduit 52 is connected at its first end to the second vessel 26. The first vertical conduit 54 is connected at its first end to the first horizontal conduit 52, and at its second end to the junction 35. The first horizontal conduit 52 extends substantially parallel to the floor 18. The first vertical conduit 54 extends substantially in an elevation direction perpendicular to the floor 18.

The first horizontal conduit 52 has a height measured along the elevation direction preferably between 1400 mm and 1650 mm, advantageously 1560 mm, relative to the junction 35. In particular, the height of the first horizontal conduit 52 makes it possible for the first horizontal conduit 52 to pass above an operator in the transportable container 16, to allow him to move around the container more easily.

Advantageously, the first horizontal conduit 52 extends along a side wall 19, the maximum distance between the first horizontal conduit 52 and said side wall 19 being less than or equal to 100 mm. This configuration in particular further frees up space in the interior volume to makes it possible for the operator to move around the container 16 more easily.

The first dispensing circuit 40 is capable of dispensing the urea solution mixed with the additive or the urea solution without the additive.

The first dispensing circuit 40 comprises a first free outlet 56. The first outlet 56 is capable of directly delivering the urea solution mixed with the additive or the urea solution without the additive.

The first outlet 56 opens into the second compartment 22. The first outlet 56 extends to a height accessible to an operator when the operator retrieves the urea solution mixed with the additive or the urea solution without the additive in the second compartment 22. To this end, the first outlet 56 extends substantially at the height of an operator, relative to the floor 18.

Advantageously, the first outlet 56 is fluidically connectable to a dispensing gallows. When the first outlet 56 is connected to the dispensing gallows, the first dispensing circuit 40 is capable of filling individual receptacles.

Advantageously, the first dispensing circuit 40 also comprises a first dispensing valve 58 (visible in FIG. 1), configurable between an open position in which fluid in the first dispensing circuit 40 is capable of being delivered through the first outlet 56, and a closed position in which the flow of a liquid in the first dispensing circuit 40 through the first dispensing valve 58 is interrupted.

Advantageously, the first dispensing valve 58 is arranged in the second compartment 22. Thus, a user in the second compartment 22 is capable of opening or closing the first dispensing valve 58 in order to start or stop the flow of liquid through the first outlet 56.

Advantageously, the first dispensing circuit 40 further comprises a first transfer pump 62 configured to transfer the urea solution with or without additive to the first outlet 56. The first transfer pump 62 is capable of transferring liquid at a flow rate of between 25 L/min and 50 L/min, and preferably equal to 35 L/min. The relatively low flow rate of the first transfer pump 62 is adapted for filling individual containers with relatively small internal volumes, for example between 10 liters and 1000 liters.

Similar to the first fluidic circuit 30, the second fluidic circuit 32 comprises a first additional fluidic circuit 66 at an additional junction 68, at least a second additional fluidic circuit 70 connecting the second vessel 26 to the additional junction 68, and a second dispensing circuit 72 connected to the additional junction 68. Thus, the additional junction 68 places the second additional fluidic circuit 70 in fluidic communication with the first additional fluidic circuit 66.

The characteristics of the first additional fluidic circuit 66, the additional junction 68, the second additional fluidic circuit 70, and the second dispensing circuit 72 are identical to the first fluidic circuit 34, the junction 35, the second fluidic circuit 36, and the first dispensing circuit 40, respectively, and will not be described again in detail.

In particular, the second additional fluidic circuit 70 comprises a second valve 45, configurable between an open position in which the first additional fluidic circuit 66 is in fluidic communication with the second additional fluidic circuit 70 so as to mix the urea solution and the additive, and a closed position in which the fluidic communication between the first additional fluidic circuit 66 and the second additional fluidic circuit 70 is interrupted.

Advantageously, the second additional fluidic circuit 70 comprises a second metering pump 76, different from the first metering pump 46 described above, capable of regulating the amount of additive flowing to the additional junction 68. The second metering pump 76 of the second additional circuit 70 is capable of transferring liquid at a flow rate of between 20 L/h and 45 L/h, and preferably equal to 33 L/h. The second metering pump 76 thus has a higher flow rate than the first metering pump 46. This makes the second metering pump 76 compatible with preparing a final product for a large volume vessel of a volume greater than that of an individual canister. Said large volume vessel has an internal volume of between 20 m³ and 35 m³, for example, and advantageously equal to 25 m³.

The second dispensing circuit 72 comprises a second outlet 78. The second outlet 78 is capable of directly delivering the urea solution mixed with the additive or the urea solution without the additive. The second outlet 78 is also capable of receiving the urea solution delivered from the urea solution reservoir 14.

The second outlet 78 extends to an accessible height for an operator when the container 16 is placed on a trailer to facilitate its retrieval of liquids at the second outlet 78. To this end, the second outlet 78 extends substantially at the floor 18 of the container 16.

The second outlet 78 is fluidically connectable to the urea solution reservoir 14. The second outlet 78 is detachably connected to the urea solution reservoir 14, via a pipe, for example.

The second outlet 78 opens into a side wall 19 of the transportable container 16.

Advantageously, the second fluidic circuit 36 further comprises a second transfer pump 80, different from the first transfer pump 62 described above, configured to transfer the urea solution with or without additive to the second outlet 78. The second transfer pump 80 is capable of transferring liquid at a flow rate of between 250 L/min and 600 L/min, and preferably equal to 417 L/min. The second transfer pump 80 thus has a higher flow rate than the first transfer pump 62. This makes the second transfer pump 80 compatible with filling a large volume vessel, of a volume greater than that of an individual canister, at a higher rate.

Advantageously, the second fluidic circuit 36 further comprises a direct fluidic circuit 84 of the urea solution connecting the first vessel 24 to the second outlet 78. The urea solution reservoir 14 is adapted to fill the first vessel 24 directly through the direct fluidic circuit 84, without passing through the first additional fluidic circuit 66 or the second additional fluidic circuit 70.

Thus, the direct fluidic circuit 84 makes it possible to replenish the urea solution of the dispensing system 12 from the urea solution reservoir 14.

Advantageously, the direct fluidic circuit 84 has no pump. In fact, the urea solution reservoir 14 comprises a reservoir pump (not shown in the Figures) at the outlet of the urea solution reservoir 14, with the reservoir pump intended to transfer the urea solution from the urea solution reservoir 14 to the direct fluidic circuit 84.

According to this embodiment, the second outlet 78 is both capable receiving the urea solution from the urea solution reservoir 14, to replenish the first vessel 24, and of delivering the urea solution mixed with the additive or without the additive to a final product tank other than the urea solution reservoir 14.

In a variant, in place of the urea solution reservoir 14, the first vessel 24 is capable of being connected to an additional vessel containing the urea solution in order to increase the amount of urea solution delivered from the dispensing system 12. The connection between the first vessel 24 and the additional vessel is preferably made via a connecting pipe. The connecting pipe has a first end capable of being screwed onto the connecting valve of the first vessel 24, and a second end capable of being connected to the additional vessel outlet. Screwing is carried out by a simple screwing of the hose coupling type, for example.

The said additional vessel is preferably a tank container, also known as “ISO tank container”. This tank container contains the urea solution.

The second compartment 22 has a smaller volume than the volume of the first compartment 21.

The second compartment 22 may be intended to accommodate users who have individual canisters to be filled through the first outlet 56. The separation of the first and second compartments 21, 22 by the separation wall 20 makes it possible to isolate the first set 30 of fluidic circuits and users with individual canisters, in order to ensure the safety of users. Advantageously, the separation wall 20 also makes it possible to isolate the second set 32 of fluidic circuits and the second compartment 22.

Advantageously, the second compartment 22 is capable of receiving at least one tank container containing the urea solution and/or the additive. The tank container has an internal volume of between 800 L and 1200 L, and preferably equal to 1000 L.

Advantageously, the transportable container 16 comprises at least one window in its wall, opening to a transfer pump, to facilitate access thereto.

The individual canister preferably has a volume of less than or equal to 15 L, advantageously less than or equal to 10 L, still advantageously less than or equal to 2.5 L.

The final product tank is preferably a tank of a transport vehicle such as a truck. It has a volume strictly greater than the volume of an individual canister. It preferably has a volume between 20 m³ and 35 m³, and advantageously equal to 25 m³.

Thanks to the invention described above, it is now possible to deliver the mixed urea solution with or without additive to any vessel type. Indeed, the first outlet 56 can be connected to a manually transportable vessel, preferably having a volume of less than or equal to 10 liters, in particular less than or equal to 5 liters, to satisfy the needs of individual uses. If necessary, the second outlet 78 can be connected to a vessel with a larger capacity, preferably greater than or equal to 10 m³, or a pump for dispensing the urea solution. The transportability of the container 16, in which the first and second vessels 24, 26 are arranged, makes it possible both to refill large tanks or pumps of urea solution at a service station and to supply the urea solution mixed with or without additive to private individuals directly in places without service stations equipped with large vessels or pumps of urea solution.

In addition, the entire dispensing system 12 is transportable. Thus, it is possible to move the dispensing system 12 to remote locations to provide the urea solution and the urea solution mixed with the additive.

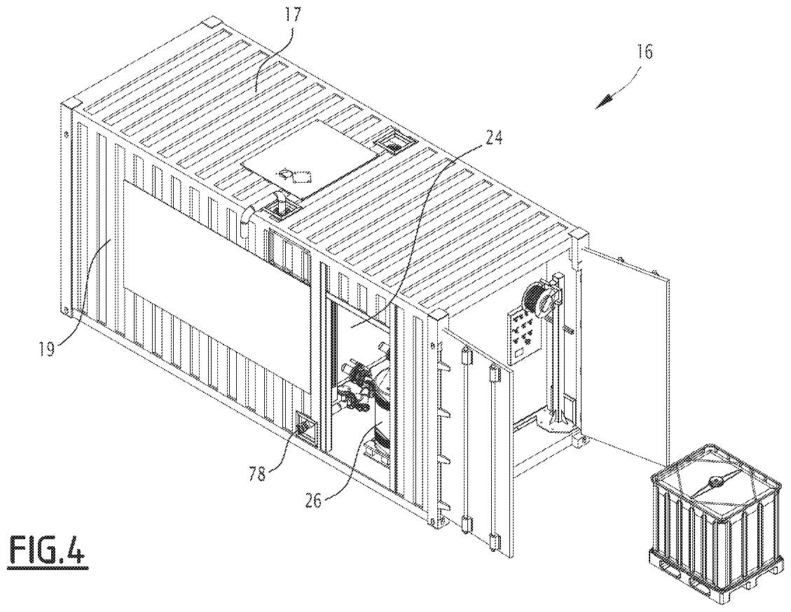

According to a second embodiment of the invention shown in FIG. 4, the transportable container 16 is a 20-foot container.

According to this embodiment, the transportable container 16 preferably has no separation wall, and comprises a single compartment 21. The first and second vessels 24, 26 are arranged in this single compartment 21.

According to this embodiment, the first vessel 24 has a volume substantially equal to 15 m³.

Optionally, and as illustrated in FIG. 1, the dispensing system 12 comprises a third vessel 88 of a second type of additive and a third fluidic circuit 90 connecting the third container 88 to the first dispensing circuit 40, in particular to the junction 35, so that it is possible to provide a final product at the outlet 56, among the urea solution without additive, the urea solution mixed with the first type of additive contained in the second vessel 26, the urea solution mixed with the second type of additive contained in the third vessel 88 or the urea solution mixed with the first and second types of additives.

Preferably, the second type of additive is a colorant for the urea solution or for the first type of additive. In a variant, the second type of additive is a performance additive, to improve the efficiency of the urea solution in treating NOx: a second alcohol, a metal, etc.

It is understood that other vessels and corresponding fluid circuits could be added according to the needs of mixing the urea solution with different types of additives.

1. A dispensing system for dispensing a urea solution, comprising a transportable container and comprising, inside the container:
at least a first vessel containing a urea solution,
at least a second vessel containing an additive for the urea solution, and
at least a first set of fluidic circuits, comprising:
a first fluidic circuit, connecting the first vessel to a junction,
at least a second fluidic circuit, connecting the second vessel to the junction, the junction placing the second fluidic circuit in fluidic communication with the first fluidic circuit,
the second fluidic circuit comprising a first valve, configurable between an open position in which the first fluidic circuit is in fluidic communication with the second fluidic circuit so as to mix the urea solution and the additive, and a closed position in which fluidic communication between the first fluidic circuit and the second fluidic circuit is interrupted, and
a first dispensing circuit, connected to the junction, the first dispensing circuit comprising a first outlet adapted to deliver the urea solution mixed with the additive or the urea solution without the additive.

2. The dispensing system according to claim 1, wherein the urea solution is an aqueous urea solution, the urea concentration in the aqueous solution being substantially equal to 32.5% and meeting the ISO22241 standard.

3. The dispensing system according to claim 1, having a second set of fluidic circuits comprising:
a first additional fluidic circuit, connecting the first vessel to an additional junction,
at least a second additional fluidic circuit, connecting the second vessel to the additional junction, the additional junction placing the second additional fluidic circuit in fluidic communication with the first additional fluidic circuit,
the second additional fluidic circuit comprising a second valve, configurable between an open position in which the first additional fluidic circuit is in fluidic communication with the second additional fluidic circuit so as to mix the urea solution and the additive, and a closed position in which fluidic communication between the first additional fluidic circuit and the second additional fluidic circuit is interrupted, and
a second dispensing circuit, connected to the additional junction, the second dispensing circuit comprising a second outlet, adapted to deliver the urea solution mixed with the additive or the urea solution without the additive.

4. The dispensing system according to claim 3, wherein the second fluidic circuit of the first set of fluidic circuits and/or the second additional fluidic circuit of the second set of fluidic circuits comprises a metering pump capable of regulating the amount of additive flowing to the respective junction.

5. The dispensing system according to claim 3, wherein the first dispensing circuit of the first set of fluidic circuits and/or the second dispensing circuit of the second set of fluidic circuits comprises a transfer pump configured to transfer the urea solution with or without additive to the respective outlet.

6. The dispensing system according to claim 3, wherein the second set of fluidic circuits comprises a direct fluidic circuit of the urea solution connecting the first vessel to the second outlet of the second set of fluidic circuits, the direct fluidic circuit being without a pump.

7. The dispensing system according to claim 1, wherein the first vessel has a volume greater than or equal to 1 m³.

8. The dispensing system according to claim 1, wherein the additive is selected among polyalkoxylated alcohols, preferably having ethoxylated and/or propoxylated groups, preferably having a hydrophilic/lipophilic balance of between 7 and 17.

9. The dispensing system according to claim 1, comprising, inside the container:
at least a third vessel of an additional additive for the urea solution,
at least a third fluidic circuit, connecting the third vessel to the junction, the junction placing the third fluidic circuit in fluidic communication with the first and second fluidic circuits,
the third fluidic circuit comprising a valve, configurable between an open position in which the first and second fluidic circuits are in fluidic communication with the third fluidic circuit so as to mix the urea solution with the additive and/or with the additional additive, and a closed position in which the fluidic communication between the first and second fluidic circuits and the third fluidic circuit is interrupted,
the first outlet being capable of delivering the urea solution mixed with the additive, the urea solution mixed with the additional additive, the urea solution mixed with the additive and the additional additive or the urea solution without the additive and additional additive.

10. A dispensing installation, comprising a dispensing system according to claim 1 and a receptacle fluidically connected to the first outlet, the dispensing system being capable of injecting the urea solution mixed with the additive or the urea solution without the additive into a canister.

11. The dispensing installation according to claim 10, wherein the dispensing system has a second set of fluidic circuits comprising:
a first additional fluidic circuit, connecting the first vessel to an additional junction,
at least a second additional fluidic circuit, connecting the second vessel to the additional junction, the additional junction placing the second additional fluidic circuit in fluidic communication with the first additional fluidic circuit,
the second additional fluidic circuit comprising a second valve, configurable between an open position in which the first additional fluidic circuit is in fluidic communication with the second additional fluidic circuit so as to mix the urea solution and the additive, and a closed position in which fluidic communication between the first additional fluidic circuit and the second additional fluidic circuit is interrupted, and
a second dispensing circuit, connected to the additional junction, the second dispensing circuit comprising a second outlet, adapted to deliver the urea solution mixed with the additive or the urea solution without the additive,
the dispensing installation further comprising a final product tank fluidically connected to the second outlet, the dispensing system being capable of injecting the urea solution mixed with the additive or the urea solution without the additive into the final product tank, the volume of the final product tank having a volume strictly greater than the volume of the canister.
